(19) United States
(12) Patent Application Publication
(10) Pub. No.: US 2026/0362076 A1
(43) Pub. Date: Nov. 12, 2026

(54) METHOD FOR GENERATING AN AUDIO SCENE IN A BINAURAL SPATIALISATION SYSTEM

(71) Applicant: MUSIC UNIT, MONTREUIL (FR)

(72) Inventors: Matthieu AUSSAL, Saint-Arnoult-En-Yvelines (FR); Jean-Christophe MESSONNIER, Paris (FR)

(73) Assignee: MUSIC UNIT, MONTREUIL (FR)

(21) Appl. No.: 19/487,585

(22) PCT Filed: May 24, 2024
(86) PCT No.: PCT/EP2024/064427

§ 371 Date: Nov. 25, 2025

(30) Foreign Application Priority Data
May 25, 2023 (FR) 2305172

(51) Int. Cl. H04S 7/00; H04S 1/00

(52) U.S. Cl. CPC H04S 7/304; H04S 1/002; H04S 2420/01

(57) ABSTRACT

The invention relates to a method for generating an audio scene in a binaural spatialization system, the method comprising a step of providing a set of primary auditory transfer functions, relating to the left ear and to the right ear of individuals, recorded on a set of N individuals, a preliminary preparation step, with conversion to logarithmic values, and symmetrization of the spectral amplitude, a step of smoothing the spectral amplitude by binaural relative gap, normalization for a reference direction (θ₀,φ₀) with averaging over the subjects, with flattening of the amplitudes on the ipsilateral side on a frontal cap (CF), a step of evaluating the mean interaural time difference, a step of generating a set of reprocessed transfer functions, to generate in real time an audio scene using a binaural renderer, with one or more point audio sources at prescribed positions.

The invention relates to a method for generating an audio scene in a binaural spatialization system. The invention also relates to a system and headphones wherein the proposed method can be implemented.

Generally speaking, there is a growing need to synthesize a three-dimensional audio scene, whether to reproduce stereophonic musical listening on headphones or earbuds or earplugs, or in the case of immersion scenarios in virtual reality with a virtual reality headset.

Binaural hearing occurs when both of an individual's ears receive specific sound signals, corresponding to a perception of sounds in space that allows the auditory system and the individual's brain to determine the direction of origin of a sound.

By virtue of binaural hearing, spatialized sound reproduction allows a listener to perceive sound sources coming from any direction or position in space, and to have the impression of being immersed in a three-dimensional sound scene.

The signals received by the listener's right and left ears are differentiated, notably but not exclusively, by their intensity and by their arrival delay and phase.

The term “multichannel”, used in spatial sound processing, refers to the representation of an acoustic scene in the form of P signals (referred to as spatial components). These signals contain all the sounds that make up the sound scene, but with weightings that depend on their direction (or “incidence”) and are described by P associated spatial rendering functions. It should be noted, however, that the proposed method also works for a scene with a single audio source.

The particular techniques of spatialized sound reproduction to which the present invention relates are based on the existence of acoustic transfer functions of the head between spatial positions and the auditory canal. These transfer functions, referred to as HRTFs (Head Related Transfer Functions), relate to the frequency form of the transfer functions. Hereinafter, their temporal form will be referred to as “HRIR” (for “Head Related Impulse Response”).

In particular, a set of auditory transfer functions will be examined comprising, for a given individual and for a plurality of measured positions M: a frequency transfer function for the left ear (HRTFg(M)(f)), a frequency transfer function for the right ear (HRTFd(M)(f)), an impulse response function for the left ear (HRIRg(M)(t)) and an impulse response function for the right ear (HRIRd(M)(t)).

There are public databases wherein these auditory transfer function measurements have been cataloged for a plurality of individuals. In the remainder of this document, a particular individual will be assigned the index ‘I’, and the number of individuals will by convention be equal to N.

The ear referred to as the ipsilateral ear is the ear that receives sound first, and the ear referred to as the contralateral ear is the ear that receives sound second from the same sound source. In the remainder of this document, the left hemisphere is defined as the half-sphere located to the left of the sagittal plane referenced by the listener's head in the straight position, and the right hemisphere as the half-sphere located to the right of this sagittal plane.

The left ear is the ipsilateral ear for sounds from the left hemisphere, and the right ear is the ipsilateral ear for sounds from the right hemisphere.

To generate a sound scene by synthesis in a binaural renderer, a convolution operation is performed between the sound sources of the scene and the temporal impulse responses, respectively right and left, or if working in the frequency domain, a spectral multiplication operation followed by an inverse Fourier transform.

Using a set of auditory transfer functions measured on a particular individual has proven not to be satisfactory, if used for a general binaural renderer used for a general audience.

Averaging out the measurements of N individuals and deriving a set of average auditory transfer functions is also not fully satisfactory.

Some have tried to work on the phase of transfer functions, for example in document U.S. Pat. No. 10,609,504, but the subjective results still leave much to be desired.

The inventors have sought to improve the situation, in particular by reworking transfer function sets from public database(s), with a particular focus on binaural rendering in headphones. Particular attention is paid to restoring the timbre of audio sources, and to eliminating possible comb-filter effects.

The method and the proposed system can also be used in a so-called “transaural” context with loudspeaker listening.

The inventors also kept in mind the need to offer individualization to the listener, who will be immersed in the three-dimensional audio scene.

To this end, proposed herein is therefore a method for generating an audio scene in a binaural spatialization system, the method being characterized in that it comprises:
S0—a step of providing a set of primary (basic) auditory transfer functions, relating to the left ear and to the right ear of individuals, recorded on a set of N individuals, the set of primary auditory transfer functions comprising, for each individual I and for each of a plurality of measured positions Mj:
a frequency transfer function for the left ear (HRTFg(i,Mj)(f)) denoted

$${H}_{g}^{i} ( {θ}_{j} , {ϕ}_{j} )$$

and comprising amplitude and phase,
a frequency transfer function for the right ear (HRTFd(i,Mj)(f)) denoted

$${H}_{d}^{i} ( {θ}_{j} , {ϕ}_{j} )$$

and comprising amplitude and phase,
a temporal impulse response function for the left ear (HRIRg(i,Mj)(t)) denoted

$${h}_{g}^{i} ( {θ}_{j} , {ϕ}_{j} )$$

and a temporal impulse response function for the right ear (HRIRd(i,Mj)(t)) denoted

$${h}_{d}^{i} ( {θ}_{j} , {ϕ}_{j} ) ,$$

each position Mj having polar coordinate directions q and D; (azimuth and elevation), the method comprising:
SA—a preliminary preparation step, noted SA, with conversion to logarithmic values with, if necessary (if this has not already been done in the public or private primary database), symmetrization of the spectral amplitude for all directions (θ, φ) of a subject i, using an averaging function FA, in accordance with the formulation:

$$\begin{matrix}{L}^{i} ( θ , ϕ ) = FA ( dB ( {H}_{g}^{i} ( {θ}_{j} , {ϕ}_{j} ) ) , dB ( {H}_{d}^{i} ( - {θ}_{j} , {ϕ}_{j} ) ) ) \\ {R}^{i} ( θ , ϕ ) = F A ( dB ( {H}_{d}^{i} ( {θ}_{j} , {ϕ}_{j} ) ) , dB ( {H}_{g}^{i} ( - {θ}_{j} , {ϕ}_{j} ) ) )\end{matrix}$$

the function dB being the decimal logarithm function, and the function FA being, in a simplified case, the half-sum,
SB—a step, noted SB, of smoothing the spectral amplitude by binaural relative gap, normalization for a reference direction (θ₀, φ₀) with averaging over the subjects, according to the formulation:

$$\begin{matrix}dB ( {H}_{l} ( θ , ϕ ) ) = \frac{1}{N} {\sum }_{i}^{N} ( {L}^{i} ( θ , ϕ ) - {L}^{i} ( {θ}_{0} , {ϕ}_{0} ) ) \\ dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )\end{matrix}$$

SD—a step, noted SD, of evaluating the mean interaural time difference;

$$\begin{matrix}{I}_{l} ( θ , ϕ ) = \frac{1}{N} {\sum }_{i}^{N} arg max ( \vert {h}_{g}^{i} ( θ , ϕ ) * w \vert ) \\ {I}_{r} ( θ , ϕ ) = \frac{1}{N} {\sum }_{i}^{N} arg max ( \vert {h}_{d}^{i} ( θ , ϕ ) * w \vert ) \\ τ ( θ , ϕ ) = \frac{1}{f s} ( {I}_{r} ( θ , ϕ ) - {I}_{l} ( θ , ϕ ) )\end{matrix}$$

fs being the sampling frequency of the HRIR impulse responses, and argmax(uₙ) being the index of the maximum of a sequence uₙ where * is the convolution product, w is a convolution filter function, which can be reduced to a Dirac pulse (in which case the largest signal peak is simply selected),
SF—a step, noted SF, of generating a set of reprocessed transfer functions, noted HHₗ and HHᵣ,

HHₗ(θ,φ)=10^{dB(H}^{ₗ}^{(θ,φ))/20}

HHᵣ(θ,φ)=10^{dB(H}^{ᵣ}^{(θ,φ))/20}e^{iτ(θ,φ)}
SR—a step, noted SR, of using the reprocessed functions HHₗ(θ, φ) and HHᵣ(θ, φ) to generate in real time an audio scene using a binaural renderer, with one or more point audio sources at prescribed positions.

By virtue of the provisions described above, the development and use of reprocessed transfer functions gives very satisfactory results. The timbre of the audio source(s) is reproduced very satisfactorily for a group of users from a tested panel.

It is further noted that normalizing spectral filter amplitudes with respect to a reference direction (θ₀,φ₀) is particularly beneficial, especially from the point of view of overall balancing.

Advantageously, comb filter effects are eliminated.

The averaging effect with respect to all the individuals measured makes it possible to work on an average individual and maximize the suitability of the reprocessed transfer functions with respect to the general population able to use devices implementing the proposed method.

It will be noted that the number of audio sources involved in the generation of synthesized audio signals is arbitrary. A single audio source may correspond to the case of a video conference with one person delivering a speech at one location with no other sound source in the audio scene. In other configurations, a multiple sound environment is provided, with multiple sound sources in front of and behind the listeners, as in the case of immersion in a video game with subjective views (e.g. FPS for ‘First Person Shoot’), or as in the case of simulators of all types.

It should also be noted that, according to the proposed procedure, a switch is made to logarithmic values to perform calculations and then, conversely, a switch is made back to linear values before injecting the filters with their amplitudes and phases into the binaural renderer. This allows subtraction instead of division, and reduces the overall calculation load.

As will be explained later, some steps are carried out in an offline mode, that is to say upstream of actual use in a binaural renderer in an audio playback device, while conversely some steps are carried out in real time, that is to say at the time of sound wave generation in an audio playback device. As will be seen, there are multiple possible solutions for the functional division between offline and real-time stages.

Even more generally, proposed herein is therefore a method for generating an audio scene in a binaural spatialization system, the method comprising:
S0—a step of providing a set of primary (basic) auditory transfer functions, relating to the left ear and to the right ear of individuals, recorded on a set of N individuals, the set of primary auditory transfer functions comprising, for each individual I and for each of a plurality of measured positions Mj:
a frequency transfer function for the left ear (HRTFg(i,Mj)(f)) denoted

$${H}_{g}^{i} ( {θ}_{j} , {ϕ}_{j} )$$

and comprising amplitude and phase,
a frequency transfer function for the right ear (HRTFd(i,Mj)(f)) denoted

$${H}_{d}^{i} ( {θ}_{j} , {ϕ}_{j} )$$

and comprising amplitude and phase,
a temporal impulse response function for the left ear (HRIRg(i,Mj)(t)) denoted

$${h}_{g}^{i} ( {θ}_{j} , {ϕ}_{j} )$$

and a temporal impulse response function for the right ear (HRIRd(i,Mj)(t)) denoted

$${h}_{d}^{i} ( {θ}_{j} , {ϕ}_{j} ) ,$$

each position Mj having polar coordinate directions q and D; (azimuth and elevation), the method comprising:
SA—a preliminary preparation step, noted SA, with conversion to logarithmic values with, if necessary (if this has not already been done in the public or private primary database), symmetrization of the spectral amplitude for all directions (θ, φ) of a subject i, using an averaging function FA, in accordance with the formulation:

$$\begin{matrix}{L}^{i} ( θ , ϕ ) = FA ( dB ( {H}_{g}^{i} ( {θ}_{j} , {ϕ}_{j} ) ) , dB ( {H}_{d}^{i} ( - {θ}_{j} , {ϕ}_{j} ) ) ) \\ {R}^{i} ( θ , ϕ ) = F A ( dB ( {H}_{d}^{i} ( {θ}_{j} , {ϕ}_{j} ) ) , dB ( {H}_{g}^{i} ( - {θ}_{j} , {ϕ}_{j} ) ) )\end{matrix}$$

the function dB being the decimal logarithm function, and the function FA being, in a simplified case, the half-sum,
SB—a step, noted SB, of smoothing the spectral amplitude by binaural relative gap, normalization for a reference direction (θ₀, φ₀) with averaging over the subjects, according to the formulation:

$$\begin{matrix}dB ( {H}_{l} ( θ , ϕ ) ) = \frac{1}{N} {\sum }_{i}^{N} ( {L}^{i} ( θ , ϕ ) - {L}^{i} ( {θ}_{0} , {ϕ}_{0} ) ) \\ dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )\end{matrix}$$

SD—a step, noted SD, of evaluating the mean interaural time difference, noted τ(θ,φ);
SF—a step, noted SF, of generating a set of reprocessed transfer functions, respectively noted HHₗ(θ, φ) et HHᵣ(θ, φ);
SR—a step, noted SR, of using the reprocessed functions HHₗ(θ, φ) and HHᵣ(θ, φ) to generate in real time an audio scene using a binaural renderer, with one or more point audio sources at prescribed positions.

As already mentioned above, normalizing spectral filter amplitudes with respect to a reference direction (θ₀, φ₀) is particularly beneficial, especially from the point of view of overall balancing.

According to one aspect, in step SD—, the mean interaural time difference τ(θ, φ) is calculated as follows:

$$\begin{matrix}{I}_{l} ( θ , ϕ ) = \frac{1}{N} {\sum }_{i}^{N} arg max ( \vert {h}_{g}^{i} ( θ , ϕ ) * w \vert ) \\ {I}_{r} ( θ , ϕ ) = \frac{1}{N} {\sum }_{i}^{N} arg max ( \vert {h}_{d}^{i} ( θ , ϕ ) * w \vert ) \\ τ ( θ , ϕ ) = \frac{1}{fs} ( {I}_{r} ( θ , ϕ ) - {I}_{l} ( θ , ϕ ) )\end{matrix}$$

fs being the HRIR sampling frequency, and argmax(uₙ) being the index of the maximum of a sequence uₙ, where * is the convolution product and w is a convolution filter function.

This is an example of a concrete way of calculating mean interaural time difference.

According to one aspect, in step SF—, the set of reprocessed transfer functions is calculated as follows:

HHₗ(θ,φ)=10^{dB(H}^{ₗ}^{(θ,φ))/20}

HHᵣ(θ,φ)=10^{dB(H}^{ᵣ}^{(θ,φ))/20}e^{iτ(θ,φ)}

This is an example of a concrete way of calculating the set of reprocessed transfer functions.

According to one aspect, the method may further comprise a step, noted SB2, of flattening the amplitude of the filters on a frontal cap (CFg) for the ipsilateral ear, according to the formulation:

dB(Hₗ(θ,φ))=dB(Hₗ(θ₀,φ₀))

for any direction θⱼ, φⱼ comprised in the solid angle defined by the respective terminals [0, θ₀] and [−φ₀, +φ₀] on the left side. The formula is given for a source on the left. If the source is located on the right, then dB(Hᵣ (θ, φ))=dB(Hᵣ (θ₀, φ₀)) for any direction θⱼ, φⱼ comprised in the solid angle CFd defined by the respective terminals [0, θ₀,] and [−φ₀, +φ₀] on the right side.

Advantageously, the amplitudes applied for flattening correspond to the filter amplitudes of the reference direction θ₀, φ₀ on the ipsilateral side. According to one option, the filters for the contralateral ear remain unchanged, particularly with regard to amplitudes and minimum phases.

An uncorrected flat filter is then applied to the amplitude of the ipsilateral ear filter in a front cap. The test campaigns carried out by the inventors revealed that this arrangement was favorable in terms of perceived quality on the part of the users on the test panel.

It will be noted that there are no jumps or discontinuities at the cap boundaries, as the amplitudes have been previously normalized to the reference amplitude at direction [θ₀, φ₀]. The filter is continuous and derivable over the entire range of angles.

According to another formulation of this step, the step noted SB2 of flattening the amplitude of the filters on a frontal cap (CF) can be carried out according to the formulation:

$$\begin{matrix}dB ( {H}_{l} ( θ , ϕ ) ) = \frac{1}{N} {\sum }_{i}^{N} ( {L}^{i} ( θ , ϕ ) - {L}^{i} ( \vert θ \vert , ϕ ) ) \\ dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )\end{matrix}$$

It is specified here that this step of the method flattens the HRTF on the source side, in this case the left-hand side. The same logic applies symmetrically to a source on the right.

According to one aspect, the binaural renderer further comprises a head tracking function. In practice, a 3-axis gyroscopic sensor supplies yaw, roll and pitch movements to headphones on which the binaural renderer is implemented. It will be noted here that the gyroscopic sensor can be integrated into the headphones. Alternatively, the yaw movement can be determined using one or more cameras, whether or not they are mounted on the headphones. In this way, the renderer can compensate in real time for listener head movements by calling up the corresponding inverse positions in the database: e.g. if a listener turns his head 15° to the left, a sound initially placed at 0° in front of him will shift 15° to the right.

According to one aspect, the method may further comprise, prior to step SF or during step SR, a step, noted SE, for interpolating spectral amplitudes, phases and interaural time differences.

Therefore, starting from a base of known transfer function sets with a large enough step, e.g. every 15° or every 10°, interpolation can provide a base of transfer function sets with better granularity, e.g. every 3° or even every 2°.

It should be noted that this interpolation step can be performed in the offline stages, or in real time with the binaural renderer.

According to one aspect, the spectral amplitude symmetrization step (SA) may further comprise a smoothing by local averaging of k neighboring directions j, according to the formulation:

$$\begin{matrix}{L}^{i} ( θ , ϕ ) = \frac{1}{2} {\sum }_{j}^{k} ( dB ( {w}_{j} {H}_{g}^{i} ( {θ}_{j} , {ϕ}_{j} ) ) + dB ( {w}_{j} {H}_{d}^{i} ( - {θ}_{j} , {ϕ}_{j} ) ) ) \\ {R}^{i} ( θ , ϕ ) = \frac{1}{2} {\sum }_{j}^{k} ( dB ( {w}_{J} {H}_{d}^{i} ( {θ}_{j} , {ϕ}_{j} ) ) + dB ( {w}_{j} {H}_{g}^{i} ( - {θ}_{j} , {ϕ}_{j} ) ) )\end{matrix}$$

In this way, filters are smoothed not only on individuals, but also in space.

According to one aspect, the method may further comprise a step of individualizing the interaural time difference (SG) based on a head radius b of a target listener, the interaural time difference being determined by

$$\frac{b}{a} τ$$

where b is the new head radius and a is the original radius, that is to say the reference head radius.

According to one aspect, the method may further comprise a step, noted SH, of angular correction, in fact azimuthal angular correction, with a parameter γ that can be adapted to each user, according to the formulation:

f(θ,φ)=(θ+γ*sin(2θ),φ)

The parameter γ is preferably parameterizable, and can even be individualized according to the listener benefiting from the binaural audio rendering.

In other words, instead of using the azimuth angle θ directly, a transform of the azimuth angle is instead used in the form θ+γ*sin(2θ). It turns out that this angular deformation further enhances the qualitative result.

According to a related aspect, the method may comprise a step, noted SH, of angular correction with angular correction in azimuth and elevation, where the angles θ,φ in the HRTF formulas are replaced by the angles (θ′,φ′) such that (θ′,φ′)=f (θ,φ).

According to one example, it is possible to choose (θ′,φ′)=f(θ,φ)=(θ+γ*sin(2θ), φ+γ′*sin(φ)).

The parameters γ and γ′ can be adapted to each user.

In other words, instead of using the azimuth angle θ directly, a transform of the azimuth angle is instead used in the form θ+γ*sin(2θ), and instead of using the elevation angle φ directly, a transform of the elevation angle is instead used in the form φ+γ′*sin(φ).

According to one aspect, the method may further comprise a step, noted SC, of symmetrization and averaging of the phase, according to the formulation:

$$\begin{matrix}< {H}_{l} ( θ , ϕ ) >= \frac{1}{2 N} {\sum }_{i}^{N} ( < {H}_{g}^{i} ( θ , ϕ ) > + < {H}_{d}^{i} ( ( - {θ}_{j} , {ϕ}_{j} ) > ) \\ < {H}_{r} ( θ , ϕ ) > = \frac{1}{2 N} {\sum }_{i}^{N} ( < {H}_{d}^{i} ( θ , ϕ ) > + < {H}_{g}^{i} ( ( - {θ}_{j} , {ϕ}_{j} ) > )\end{matrix}$$

The notation <.> refers to the phase of the complex transfer function.

This further improves the averaging function of the individuals who took part in the transfer function measurement campaigns.

The invention also relates to headphones configured to implement steps SE to SR of a method as previously described. Depending on the configuration, the headphones can perform steps SG to SR or SH to SR.

The invention also relates to a processing system configured to implement steps S0 to SG of a method as described above.

According to another embodiment of the present invention, starting from certain HRTF filter bases, possibly already symmetrized, the flattening defined in step SB2 is simply applied. In this case, it may be necessary to continuously connect the filters to the edge of the cap CFg, (respectively CFd) to guarantee the absence of skipping. This can be done by polynomial interpolation.

The invention will be further detailed by the description of non-limiting embodiments, and based on the attached figures showing variants of the invention, wherein:

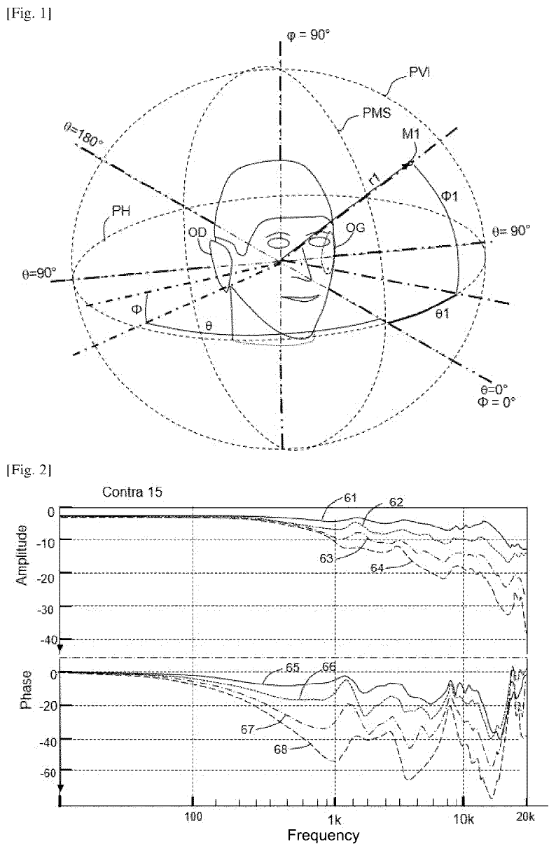

FIG. 1 is a schematic diagram showing the spherical coordinates of points and directions in space around an individual, for example a listener in the context of listening or in the context of measuring HRTF auditory transfer functions;

FIG. 2 shows an example of the amplitude of the frequency transfer function, plus phase, for the contralateral ear, normalized to the 15° direction;

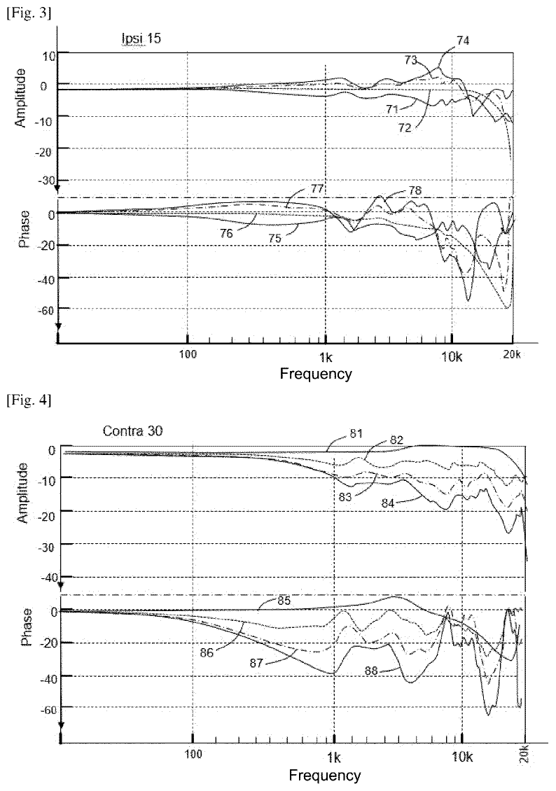

FIG. 3 shows an example of the amplitude of the frequency transfer function, plus phase, for the ipsilateral ear, normalized to the 15° direction;

FIG. 4 shows an example of the amplitude of the frequency transfer function, plus phase, for the contralateral ear, normalized to the 30° direction, and flattening on the frontal cap;

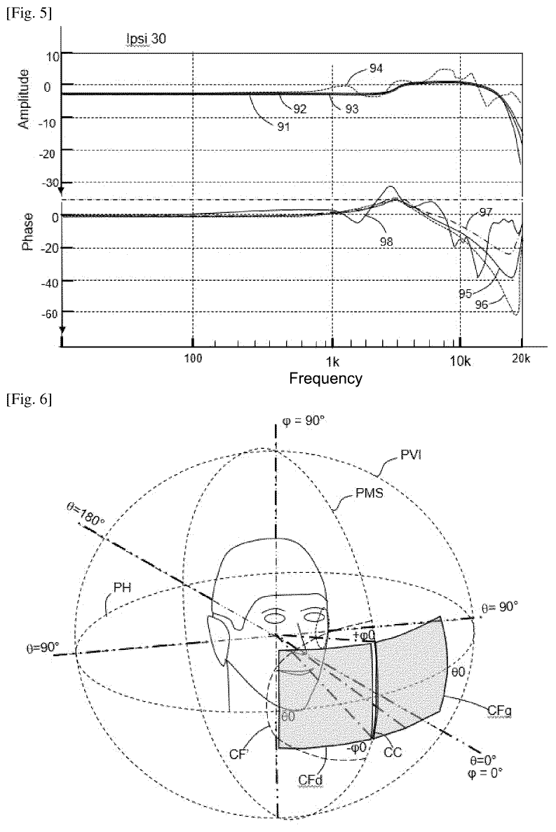

FIG. 5 shows an example of the amplitude of a frequency transfer function, plus phase, plus phase, for the ipsilateral ear, normalized to the 30° direction, and flattening on the frontal cap;

FIG. 6 is analogous to FIG. 1 and shows in particular areas of the frontal cap where the filtering spectra are flattened;

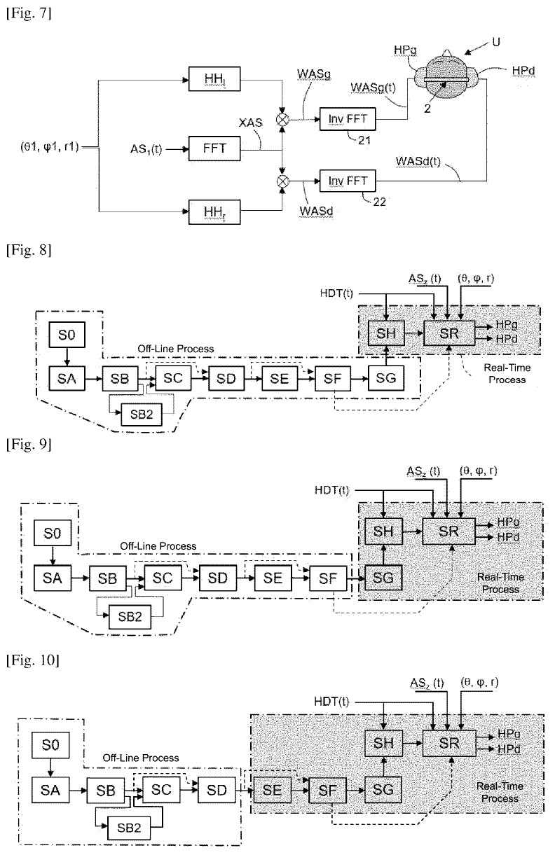

FIG. 7 schematically shows the rendering of an audio scene using a binaural renderer, for a single audio source AS₁;

FIG. 8 schematically shows an example of the sequence of steps in the proposed method according to a first hardware implementation variant;

FIG. 9 schematically shows an example of the sequence of steps in the proposed method according to a second hardware implementation variant;

FIG. 10 schematically shows an example of the sequence of steps in the proposed method according to a third hardware implementation variant.

In the various figures, the same references designate identical or similar elements. For reasons of clarity, some elements may not be shown to scale.

### GENERAL AND SYSTEM

Generally speaking, binaural spatial sound reproduction allows a listener U to be immersed in an audio scene and to perceive sound sources coming from different directions and positions in space, while the listener U has only two loudspeakers HPg and HPd.

In the example shown in FIG. 7, the playback device is headphones 2, with the left loudspeaker HPg facing the left ear OG of the listener and the right loudspeaker HPd facing the right ear OD of the listener U.

In other configurations, the playback device can be a pair of in-ear earbuds, such as earplugs.

In yet another configuration, in a context referred to as open-air listening, sometimes called ‘Transaural™’, there are two playback devices, such as conventional loudspeakers, with cross talk cancellation. The proposed invention can also be applied in this transaural configuration, with two or more loudspeakers.

For the different configurations mentioned above, both loudspeakers can be controlled by one and the same control unit directly in wired mode, or the loudspeakers can be controlled by one and the same control unit but via a Bluetooth-type wireless link.

In one case, the audio scene to be reproduced may consist of a single sound source, noted AS₁ in FIG. 7. In another case, the audio scene to be rendered is made up of a plurality of sound sources AS₁. For example, the audio scene to be reproduced may comprise NbS sound sources.

Each sound source to be reproduced, such as the first source AS₁, is located at a position M1 characterized by its polar coordinates θ1 and φ1 and its distance r1, as shown in FIG. 1. Polar coordinates will be used throughout this document. The first coordinate θ represents the azimuth in relation to a “straight ahead” direction, with positive angles being measured to the right or left depending on the side of the source concerned. The second coordinate φ (also noted φ) corresponds to the elevation, also called the elevation angle, in relation to a horizontal direction, with positive angles being measured upwards.

In FIG. 1, the plane marked PH is the horizontal reference plane for the listener with the head straight. The plane marked PMS is the sagittal median plane, separating the left and right hemispheres. The plane marked PVI is the vertical interaural plane (it passes through θ=90°). When the system is equipped with the head movement tracking function, the deviation of the actual position from the straight position is compensated by the same angle values with an opposite sign. To the listener, the sound source always appears to be at its given position in space, irrespective of any small head movements the listener may make.

The reproduction of an audio scene is based on the use of acoustic transfer functions of the head between the positions in space (θ,φ) and the auditory canal, called auditory transfer functions. These transfer functions, referred to as HRTFs (Head Related Transfer Functions), relate to the frequency form of the transfer functions. Hereinafter, their temporal form will be referred to as “HRIR” (for “Head Related Impulse Response”), that is to say the impulse response.

In the context of binaural reproduction, the following transfer functions are used: a frequency transfer function for the left ear (HRTFg(M)(f)), a frequency transfer function for the right ear (HRTFd(M)(f)), an impulse response function for the left ear (HRIRg(M)(t)) and an impulse response function for the right ear (HRIRd(M)(t)), where M is the position of the source in polar coordinates, f is frequency and t is time.

Advantageously according to the present invention, instead of using standard transfer functions, after having modified and improved these transfer functions, reprocessed transfer functions noted HHₗ and HHᵣ are used. HHₗ and HHᵣ will denote their frequency form, and hhₗ and hhᵣ will denote their time form. How to obtain these restated transfer functions will be explained in detail later in this document.

Returning to FIG. 7, the audio scene is reproduced by a binaural renderer. The binaural renderer has reprocessed transfer functions at its disposal in their frequency or time form. By virtue of these functions, for each sound source AS₁ of the audio scene to be reproduced, characterized by the sound source's undulatory time pattern ASi(t) as well as its polar coordinates (θi,φi) and its distance from the listener ri, the binaural renderer generates the corresponding three-dimensional audio scene in both loudspeakers.

FIG. 7 shows only one sound source (θ1, φ1, r1), but the reader will understand that what follows will be repeated for each of the sound sources, and that the respective signals from the different sound sources are added in the waves produced toward the loudspeakers (HPg, HPd).

When the binaural renderer works in the frequency domain, a Fast Fourier Transform (FFT), noted XASi(f), is calculated from the temporal pattern Asi(t); in FIG. 7, this is simply denoted XAS. The coordinates (θ1, φ1, r1) of the sound source are applied to the filter HK for the left ear and to the filter HHᵣ for the right ear.

For the left channel, the fast Fourier transform XAS of the source signal is multiplied by the filter HHₗ assigned to the source coordinates, giving the signal to be reproduced in frequency form WASg. This signal is subjected to an inverse Fourier transform calculation 21, to obtain the time signal WASg(t), that is to say the image of the sound wave, which will be played on the left loudspeaker HPg.

A similar approach is adopted for the right channel, multiplying the fast Fourier transform of the source signal by the filter HHᵣ assigned to the source coordinates, giving the signal to be reproduced in frequency form WASd. This signal is subjected to an inverse Fourier transform calculation 22, to obtain the time signal WASd(t), that is to say the image of the sound wave, which will be played on the right loudspeaker HPd.

In an alternative embodiment, when the binaural renderer works in the time domain, for the left channel a convolution product is employed between the signal of the sound source ASi(t) and the impulse response function hhₗ(t) assigned the coordinates (θ1, φ1, r1) of the sound source, thus obtaining the time signal WASg(t) that will be played on the left loudspeaker HPg.

A similar approach is adopted for the right channel, using a convolution product between the signal of the sound source ASi(t) and the impulse response function hhᵣ(t) assigned the coordinates (θ1, φ1, r1) of the sound source, to obtain the time signal WASd(t) to be played on the right loudspeaker HPd.

It will be noted that to a certain extent, the left and right transfer functions (HHₗ and HHᵣ) can be customized with respect to the listener who will be experiencing the three-dimensional audio scene. This relates to head diameter adaptation to interaural time differences, azimuthal angular correction (‘gamma’ correction) or combined azimuthal and elevation angular correction.

Finally, in FIG. 7, if the head tracking function is present, it provides a real-time signal (HDT(t)) representing head movement in yaw rotation, as well as left-right lateral tilt and front-back tilt, that is to say three spatial rotation coordinates. As explained elsewhere, the renderer compensates by injecting these values with an opposite sign into the sound signal generation algorithm.

### Reprocessing and Improving Transfer Functions

The starting point is a set of primary (basic) auditory transfer functions, relating to the left ear and to the right ear of individuals, recorded on a set of N individuals, the set of primary auditory transfer functions comprising, for each individual I and for each of a plurality of measured positions Mj:
a frequency transfer function for the left ear (HRTFg(i,Mj)(f)) denoted

$${H}_{g}^{i} ( {θ}_{j} , {ϕ}_{j} )$$

and comprising amplitude and phase,
a frequency transfer function for the right ear (HRTFd(i,Mj)(f)) denoted

$${H}_{d}^{i} ( {θ}_{j} , {ϕ}_{j} )$$

and comprising amplitude and phase,
a temporal impulse response function for the left ear (HRIRg(i,Mj)(t)) denoted

$${h}_{g}^{i} ( {θ}_{j} , {ϕ}_{j} )$$

and a temporal impulse response function for the right ear (HRIRd(i,Mj)(t)) denoted

$${h}_{d}^{i} ( {θ}_{j} , {ϕ}_{j} ) ,$$

each position Mj having polar coordinate directions θⱼ and φⱼ,

In this document, frequency transfer functions are manipulated in digitized/digital form, that is to say as a sequence of values. For a large number of frequencies in the human audible spectrum, the transfer function gives amplitude and phase. There can typically be 128 frequency points listed, or even 256 frequency points listed. For each point, amplitude and phase are digitally coded on 8, 10 or 12 bits.

The different steps involved in reprocessing these raw transfer functions are shown in FIG. 8. The first step, noted S0, involves providing the above-mentioned raw transfer functions from measurements, with right/left symmetrization if required.

It is envisaged that the step of symmetrization of the spectral amplitude SA further comprises a smoothing by local averaging of k neighboring directions j, according to the formulation:

$$\begin{matrix}{L}^{i} ( θ , ϕ ) = \frac{1}{2} {\sum }_{j}^{k} ( dB ( {w}_{j} {H}_{g}^{i} ( {θ}_{j} , {ϕ}_{j} ) ) + dB ( {w}_{j} {H}_{d}^{i} ( - {θ}_{j} , {ϕ}_{j} ) ) ) \\ {R}^{i} ( θ , ϕ ) = \frac{1}{2} {\sum }_{j}^{k} ( dB ( {w}_{J} {H}_{d}^{i} ( {θ}_{j} , {ϕ}_{j} ) ) + dB ( {w}_{j} {H}_{g}^{i} ( - {θ}_{j} , {ϕ}_{j} ) ) )\end{matrix}$$

The notation dB represents the decimal logarithm function.

According to a more generic solution, this step comprises, in addition to logarithmization, if necessary symmetrization of the spectral amplitude for all directions (θ, φ) of a subject i, using an averaging function FA, according to the formulation:

$$\begin{matrix}{L}^{i} ( θ , ϕ ) = FA ( dB ( {H}_{g}^{i} ( {θ}_{j} , {ϕ}_{j} ) ) , dB ( {H}_{d}^{i} ( - {θ}_{j} , {ϕ}_{j} ) ) ) \\ {R}^{i} ( θ , ϕ ) = F A ( dB ( {H}_{d}^{i} ( {θ}_{j} , {ϕ}_{j} ) ) , dB ( {H}_{g}^{i} ( - {θ}_{j} , {ϕ}_{j} ) ) )\end{matrix}$$

if the raw transfer functions have already been pre-processed and digitized, then the step SA is simplified to logarithmic scaling.

In a simple example, the averaging function FA consists of the half-sum of the two values.

This is followed by a step, noted SB, of smoothing of the spectral amplitude by binaural relative gap, normalization for a reference direction (θ₀,φ₀) with averaging over the subjects, according to the formulation, for a source on the left:

$$\begin{matrix}dB ( {H}_{l} ( θ , ϕ ) ) = \frac{1}{N} {\sum }_{i}^{N} ( {L}^{i} ( θ , ϕ ) - {L}^{i} ( {θ}_{0} , {ϕ}_{0} ) ) \\ dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )\end{matrix}$$

The reference direction θ₀,φ₀ may correspond to θ₀=15° and φ₀=0. These filters are referred to as ‘image’ filters in the context of the present invention.

According to another solution, the reference direction θ₀,φ₀ may correspond to θ₀=30° and φ₀=0. These filters are referred to as ‘audio’ filters in the context of the present invention.

For a source on the right, it is similarly possible to apply normalization with respect to the reference direction θ₀,φ₀ on the right-hand side:

$$\begin{matrix}dB ( {H}_{l} ( θ , ϕ ) ) = \frac{1}{N} {\sum }_{i}^{N} ( {L}^{i} ( θ , ϕ ) - {L}^{i} ( {θ}_{0} , {ϕ}_{0} ) ) \\ dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )\end{matrix}$$

Then, optionally, a step, noted SB2, is further carried out to flatten the amplitude of the filters on a frontal cap CFg according to the formulation: dB(Hₗ(θ, φ))=dB(Hₗ(θ₀, φ₀)) for any direction θⱼ, φⱼ comprised in the solid angle CFg defined by the respective terminals [0,θ₀] and [−φ₀, +φ₀] on the left side.

According to a non-limiting example, the frontal cap CFg can correspond to the terminals θ₀=30° and φ₀=12°.

According to a non-limiting example, the frontal cap CFg can correspond to the terminals θ₀=20° and φ₀=8°.

It is understood that the extent of the frontal cap CF can be parameterized to suit the intended application, e.g. single-source audio scene or multi-source audio scene.

The above formula is given for a source on the left. If the source is located on the right, then dB(Hᵣ(θ, φ))=dB(Hᵣ(θ₀, φ₀)) for any direction θⱼ, φⱼ comprised in the solid angle CFd defined by the respective terminals [0,θ₀] and [−φ₀, +φ₀] on the right side.

Put another way, the frontal cap CFg or CFd is specific to the source side and confined to the source side, that is to say it is limited by the boundary CC at θ=0°.

The flattening of the filters on a frontal cap (CF) can be achieved according to the formulation otherwise written:

$$dB ( {H}_{l} ( θ , ϕ ) ) = \frac{1}{N} {\sum }_{i}^{N} ( {L}^{i} ( θ , ϕ ) - {L}^{i} ( \vert θ \vert , ϕ ) )$$

$$dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )$$

It is specified here that this method flattens the HRTF on the source side, not just the left-hand side. The same logic applies symmetrically to a source on the right.

It should also be noted that the cap CFg or CFd is not necessarily square or rectangular; it can be circular or elliptical, for example it can be delimited by the equation θ²+exc φ²<K, inside the hemisphere of the source, exc being the eccentricity of the ellipse, K being a parameter, which variant is referred to as CF′ in FIG. 6.

In addition, the phase is symmetrized and averaged in a step noted SC, according to the formulation:

$$< {H}_{l} ( θ , ϕ ) > = \frac{1}{2 N} {\sum }_{i}^{N} ( < {H}_{g}^{i} ( θ , ϕ ) > + < {H}_{d}^{i} ( ( - {θ}_{j} , {ϕ}_{j} ) > )$$

$$< {H}_{r} ( θ , ϕ ) > = \frac{1}{2 N} {\sum }_{i}^{N} ( < {H}_{d}^{i} ( θ , ϕ ) > + < {H}_{g}^{i} ( ( - {θ}_{j} , {ϕ}_{j} ) > )$$

The notation <.> refers to the phase of the complex transfer function.

The step SC can be performed at any time in relation to the other offline steps, for example at the very beginning in parallel with the step SA, or later.

In addition, a step, noted SD, is carried out to evaluate the mean interaural time difference;

$${I}_{l} ( θ , ϕ ) = \frac{1}{N} {\sum }_{i}^{N} arg max ( \vert {h}_{g}^{i} ( θ , ϕ ) * w \vert )$$

$${I}_{r} ( θ , ϕ ) = \frac{1}{N} {\sum }_{i}^{N} arg max ( \vert {h}_{d}^{i} ( θ , ϕ ) * w \vert )$$

$$τ ( θ , ϕ ) = \frac{1}{fs} ( {I}_{r} ( θ , ϕ ) - {I}_{l} ( θ , ϕ ) )$$

fs being the HRIR sampling frequency of the HRIR impulse responses, and argmax(uₙ) being the index of the maximum of a sequence uₙ of digitized values of the impulse response, where the notation * is the convolution product and w is a convolution filter function. The convolution filter function w can be reduced to a Dirac pulse (in which case the largest signal peak is simply selected).

It will be noted that the evaluation of the mean interaural time difference can be calculated using other methods, without necessarily using the above formulas.

Steps SC and SD can be performed in the order they are presented here, but the order on this point can be different, with steps SC and SD being performed before or after the other steps.

A step, noted SE, can also be performed to interpolate spectral amplitudes, phases and interferential delays. This interpolation can consist in a linear interpolation between known points. Another example involves a second-degree polynomial interpolation between known points. The final granularity may consist in providing a value every 3°, or even every 2°, in azimuth and elevation. As will be seen later, this interpolation step SE can be carried out either in offline calculations or in the real-time process.

This is followed by a step, noted SF, of generating a set of reprocessed transfer functions, noted HHₗ and HHᵣ,

HHₗ(θ,φ)=10^{dB(H}^{ₗ}^{(θ,φ))/20}

HHᵣ(θ,φ)=10^{dB(H}^{ᵣ}^{(θ,φ))/20}e^{iτ(θ,φ)}

This step SF makes it possible to return to linear mode from logarithmic mode.

If the right ear is taken as the first ear, instead of the left ear as above, then this step SF is written as follows:

HHᵣ(θ,φ)=10^{dB(H}^{ᵣ}^{(θ,φ))/20}

HHₗ(θ,φ)=10^{dB(H}^{ₗ}^{(θ,φ))/20}e^{iτ(θ,φ)}

But in fact it's all the same, with a change of sign for the angular phase shift.

It should be noted that the generation of a set of reprocessed transfer functions could be calculated differently, without necessarily using the above formulas.

Then a step can be taken to individualize the interaural delay, noted SG, based on a head radius b of a target listener, the interaural delay being determined by

$$\frac{b}{a} τ$$

with b the new head radius and a the original radius.

The radius a can be derived from measurements accompanying transfer function measurements. The radius a can be derived from anthropological data.

The radius b can be chosen based on the listener benefiting from the audio scene rendering. For example, the radius b may be smaller than a for a listener with a small head circumference; this is referred to as size XS or S.

For example, the radius b can be larger than the radius a for a listener with a large head circumference; this is referred to as size L or XL.

For example, the radius b may be larger than the radius a for a listener with an average head circumference.

This is followed by an angular correction step, noted SH.

According to a first simple example, referred to here as ‘two-dimensional’, an azimuthal angular correction is done, with a parameter γ that can be adapted to each user, according to the formulation:

f(θ,φ)=(θ+γ*sin(2θ),φ)

In other words, instead of using the azimuth angle θ directly, a transform of the azimuth angle is instead used in the form θ+γ*sin(2θ).

The value of γ is configurable.

If the ‘head movement tracking’ function is implemented, step SH performs yaw movement corrections on θ in a similar way to that described above.

According to another example of the angular correction step SH, azimuth and elevation are corrected, according to a so-called ‘three-dimensional’ deformation, using f(θ, φ)=(θ+γ*sin(2θ),φ+γ′*sin(φ)). The parameters γ and γ′ can be adapted to each user.

Even more generically, the angular correction step SH consists in replacing the angles θ,φ in the HRTF formulas with angles (θ′,φ′) such that (θ′,φ′)=f (θ,φ) f being any azimuth and elevation correction function.

FIGS. 8, 9 and 10 schematically show the above-described steps of the proposed method, according to three alternative hardware implementations. The functional breakdown differs between steps carried out in offline mode and steps carried out in real-time mode.

In FIG. 8, only steps SH and SR are performed in the target device, for example headphones, in real time with respect to the binaural rendering run. The other steps were carried out upstream, by calculation, in one or more computers. In particular, it is noted that the interpolation step SE has been performed upstream. It should also be noted that, as mentioned above, some steps are optional, e.g. steps SC, SG. It is understood that if step SG is not performed, the rendering is not customized according to the target listener's head radius. It will be noted that step SH for azimuth (and elevation, if required) angular correction can be customized to suit the target listener.

In FIG. 9, steps SG, SH and SR are performed in the target device, such as headphones. Here, step SG can be customized to suit the target listener, just like step SH. Steps SA to SF are performed upstream, by calculation, in one or more computers.

In FIG. 10, steps SE, SF, SG, SH and SR are performed in the target device, such as headphones. In particular, the interpolation step SE can be performed in real time for positions that are actually required and used by the binaural renderer. This means that memory space is limited and points of interest can be calculated at the last minute.

Steps SG and SH can be customized to suit the target listener. Only steps SA to SD are performed upstream, by calculation, in one or more computers.

The choice between different solutions may be dictated by the audio production chain, or by different hardware limitations in terms of computing capacity or available memory size.

FIGS. 2 and 3 show filters normalized with respect to the reference direction θ₀=15°, this normalization being produced by step SB described above.

In FIG. 2, curve 61 (solid line) represents the amplitude of the frequency transfer function, for the contralateral ear, for θ=0°, normalized with respect to the reference direction θ₀=15°.

Curve 62 (small dotted line) represents the amplitude of the frequency transfer function for θ=15°. Curve 63 (mixed line) represents the amplitude of the frequency transfer function for θ=30°. Curve 64 (long dotted line) represents the amplitude of the frequency transfer function for θ=45°.

Curve 65 (solid line) represents the phase of the frequency transfer function, for the contralateral ear, for θ=0°, normalized with respect to the reference direction θ₀=15°. Curve 66 (small dotted line) represents the phase of the frequency transfer function for θ=15°. Curve 67 (mixed line) represents the phase of the frequency transfer function for θ=30°. Curve 68 (long dotted line) represents the phase of the frequency transfer function for θ=45°.

In FIG. 3, curve 71 (solid line) represents the amplitude of the frequency transfer function, for the ipsilateral ear, for θ=0°, normalized with respect to the reference direction θ₀=15°.

Curve 72 (small dotted line) represents the amplitude of the frequency transfer function for θ=15°. Curve 73 (mixed line) represents the amplitude of the frequency transfer function for θ=30°. Curve 74 (solid line) represents the amplitude of the frequency transfer function for θ=45°.

Curve 75 (solid line) represents the phase of the frequency transfer function, for the ipsilateral ear, for θ=0°, normalized with respect to the reference direction θ₀=15°. Curve 76 (small dotted line) represents the phase of the frequency transfer function for θ=15°. Curve 77 (mixed line) represents the phase of the frequency transfer function for θ=30°. Curve 78 represents the phase of the frequency transfer function for θ=45°.

It will be noted that curve 72 is essentially flat, confirming the effect of normalization with respect to θ=15° for the ipsilateral ear.

FIGS. 4 and 5 show filters normalized with respect to the reference direction θ₀=30°, and flattened in a frontal cap area, these transformations being produced by steps SB and SB2 described above.

In FIG. 4, curve 81 (solid line) represents the amplitude of the frequency transfer function, for the contralateral ear, for θ=0°, normalized with respect to the reference direction θ₀=30°.

Curve 82 (small dotted line) represents the amplitude of the frequency transfer function for θ=15°. Curve 83 (mixed line) represents the amplitude of the frequency transfer function for θ=30°. Curve 84 (solid line) represents the amplitude of the frequency transfer function for θ=45°.

Curve 85 represents the phase of the frequency transfer function, for the contralateral ear, for θ=0°, normalized with respect to the reference direction θ₀=30°. Curve 86 represents the phase of the frequency transfer function for θ=15°. Curve 87 represents the phase of the frequency transfer function for θ=30°. Curve 88 represents the phase of the frequency transfer function for θ=45°.

In FIG. 5, curve 91 (solid line) represents the amplitude of the frequency transfer function, for the ipsilateral ear, for θ=0°, normalized with respect to the reference direction θ₀=30°, with flattening of the amplitude from 0° up to θ₀=30.

Curve 92 (small dotted line) represents the amplitude of the frequency transfer function for θ=15°. Curve 93 (mixed line) represents the amplitude of the frequency transfer function for θ=30°. Curve 94 (solid line) represents the amplitude of the frequency transfer function for θ=45°.

Curve 95 (solid line) represents the phase of the frequency transfer function, for the ipsilateral ear, for θ=0°, normalized with respect to the reference direction θ₀=30°. Curve 96 (small dotted line) represents the phase of the frequency transfer function for θ=15°. Curve 97 (mixed line) represents the phase of the frequency transfer function for θ=30°. Curve 98 (solid line) represents the phase of the frequency transfer function for θ=45°.

It will be noted that curves 91, 92, 93 are flat, confirming the effect of flattening and normalization with respect to 30°, over the entire range from 0° to 30° (0°, 15° and 30° identical here).

These curves show that the contralateral ear is affected in the same way in HRTFs normalized to 15° (‘image’) and normalized to 30° (‘audio’);

### OTHER CONSIDERATIONS

The reprocessed filters produced by steps SA to SG or SH constitute an enhanced database which can be made available to third parties for collaboration, licensing or sale.

The inventors noticed that other competing bases such as those from Dolby™ or the like have more erratic amplitudes between 1 kHz and 10 kHz and give poorer results.

Optionally, because of symmetrization, it is possible to store filters only for one hemisphere, right or left, and to use a plane symmetry with respect to the sagittal plane PMS created by the real-time binaural renderer.

More specifically, in practice, after the phase and amplitude symmetrization steps SA and SC, it is possible to retain data for one hemisphere only, and perform the complementary transformations in steps SB, SB2, SD on one hemisphere only. The process for the other hemisphere will be reconstructed in real time by plane symmetry with respect to the sagittal plane PMS. In this way, memory space can be divided by 2, which may be relevant for certain categories of hardware or audio processing chains.

According to another embodiment of the present invention, starting from certain HRTF filter bases, possibly already symmetrized, the flattening defined in step SB2 explained above is simply applied. In this case, it may be necessary to connect the filter amplitudes continuously to the edge of the cap CFg (respectively CFd) to guarantee that there is no jump. This can be done by polynomial interpolation.

As a further optional feature, in addition to the transformations described above, an additional transformation may be provided, consisting in raising the high-pitched tones collectively on all the filters. For example, sounds with frequencies above 2 or 3 kilohertz can be reinforced, with an amplitude of between 1 dB and 3 dB, for example.

This is shown in FIG. 5, where curves 91, 92, 93 together show an increase in amplitude above 3 kilohertz. It will be noted that because of this feature, the low-frequency plateau has been shown shifted below 0 dB.

1. A method for generating an audio scene in a binaural spatialization system, the method being characterized in that it comprises:
S0—a step of providing a set of primary auditory transfer functions, relating to the left ear and to the right ear of individuals, recorded on a set of N individuals, the set of primary auditory transfer functions comprising, for each individual i and for each of a plurality of measured positions Mj:
a frequency transfer function for the left ear (HRTFg(i,Mj)(f)) denoted
$${H}_{g}^{i} ( {θ}_{j} , {ϕ}_{j} )$$
and comprising amplitude and phase,
a frequency transfer function for the right ear (HRTFd(i,Mj)(f)) denoted
$${H}_{d}^{i} ( {θ}_{j} , {ϕ}_{j} )$$
and comprising amplitude and phase,
a temporal impulse response function for the left ear (HRIRg(i,Mj)(t)) denoted
$${h}_{g}^{i} ( {θ}_{j} , {ϕ}_{j} )$$
and a temporal impulse response function for the right ear (HRIRd(i,Mj)(t)) denoted
$${h}_{d}^{i} ( {θ}_{j} , {ϕ}_{j} ) ,$$
each position Mj having polar coordinate directions θⱼ and Φj, are inclusive of:
SA—a preliminary preparation step, noted SA, with conversion to logarithmic values with, if necessary, symmetrization of the spectral amplitude for all directions (θ, φ) of a subject i, using an averaging function FA, in accordance with the formulation:
$${L}^{i} ( θ , ϕ ) = FA ( dB ( {H}_{g}^{i} ( {θ}_{j} , {ϕ}_{j} ) ) , dB ( {H}_{d}^{i} ( - {θ}_{j} , {ϕ}_{j} ) ) )$$
$${R}^{i} ( θ , ϕ ) = FA ( dB ( {H}_{d}^{i} ( {θ}_{j} , {ϕ}_{j} ) ) , dB ( {H}_{g}^{i} ( - {θ}_{j} , {ϕ}_{j} ) ) )$$
the function dB being the decimal logarithm function,
SB—a step, noted SB, of smoothing the spectral amplitude by binaural relative gap, normalization for a reference direction (θ₀, φ₀) with averaging over the subjects, according to the formulation:
$$dB ( {H}_{l} ( θ , ϕ ) ) = \frac{1}{N} {\sum }_{i}^{N} ( {L}^{i} ( θ , ϕ ) - {L}^{i} ( {θ}_{0} , {ϕ}_{0} ) )$$
$$dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )$$
SD—a step, noted SD, of evaluating the mean interaural time difference, noted τ(θ,φ);
SF—a step, noted SF, of generating a set of reprocessed transfer functions, respectively HHₗ(θ, φ) et HHᵣ(θ,φ)
SR—a step, noted SR, of using the reprocessed functions HHₗ(θ,φ) and HHᵣ(θ,φ) to generate in real time an audio scene using a binaural renderer, with one or more point audio sources at prescribed positions.

2. The method according to claim 1, wherein in step SD—, the mean interaural time difference τ(θ, φ) is calculated as follows:
$${I}_{l} ( θ , ϕ ) = \frac{1}{N} {\sum }_{i}^{N} arg max ( \vert {h}_{g}^{i} ( θ , ϕ ) * w \vert )$$
$${I}_{r} ( θ , ϕ ) = \frac{1}{N} {\sum }_{i}^{N} arg max ( \vert {h}_{d}^{i} ( θ , ϕ ) * w \vert )$$
$$τ ( θ , ϕ ) = \frac{1}{fs} ( {I}_{r} ( θ , ϕ ) - {I}_{l} ( θ , ϕ ) )$$
fs being the HRIR sampling frequency, and argmax(uₙ) being the index of the maximum of a sequence uₙ, where * is the convolution product and w is a convolution filter function.

3. The method according to claim 2, wherein in step SF—, the set of reprocessed transfer functions is calculated as follows:
HHₗ(θ,φ)=10^{dB(H}^{ₗ}^{(θ,φ))/20}
HHᵣ(θ,φ)=10^{dB(H}^{ᵣ}^{(θ,φ))/20}e^{iτ(θ,φ)}

4. The method according to claim 3, further comprising a step, noted SB2, to flatten the amplitude of the filters a frontal cap (CF) according to the formulation:
$$dB ( {H}_{l} ( θ , ϕ ) ) = \frac{1}{N} {\sum }_{i}^{N} ( {L}^{i} ( θ , ϕ ) - {L}^{i} ( \vert θ \vert , ϕ ) )$$
$$dB ( {H}_{r} ( θ , ϕ ) ) = \frac{1}{N} {\sum }_{i}^{N} ( {R}^{i} ( θ , ϕ ) - {L}^{i} ( θ , ϕ ) ) + dB ( {H}_{l} ( θ , ϕ ) )$$
for any direction θⱼ, Φⱼ comprised in the solid angle defined by the terminals [−θ₀, −Φ₀] and [θ₀, Φ₀]

5. The method according to claim 3, further comprising a step, noted SB2, of flattening the amplitude of the filters on a frontal cap (CF), with dB(Hₗ(θ,φ))=dB(Hₗ(θ₀,φ₀)) for any direction θⱼ, Φⱼ comprised in the solid angle defined by the respective bounds [0, θ₀,] and [−Φ₀, +Φ₀] on the left side and dB(Hᵣ(θ,φ))=dB(Hᵣ(θ₀,φ₀)) for any direction θⱼ, Φⱼ comprised in the solid angle CFd defined by the respective bounds [0,θ₀] and [−Φ₀, +Φ₀] of the right-hand side

6. The method according to claim 1, wherein the binaural renderer further comprises a head tracking function.

7. The method according to claim 1, wherein there is further provided, prior to step SF or during step SR:
a step, noted SE, for interpolating spectral amplitudes, phases and interferential delays.

8. The method according to claim 1, wherein the step of symmetrization of the spectral amplitude (SA) further comprises a smoothing by local averaging of k neighboring directions j, according to the formulation:
$${L}^{i} ( θ , ϕ ) = \frac{1}{2} {\sum }_{j}^{k} ( dB ( {w}_{j} {H}_{g}^{i} ( {θ}_{j} , {ϕ}_{j} ) ) + dB ( {w}_{j} {H}_{d}^{i} ( - {θ}_{j} , {ϕ}_{j} ) ) )$$
$${R}^{i} ( θ , ϕ ) = \frac{1}{2} {\sum }_{j}^{k} ( dB ( {w}_{J} {H}_{d}^{i} ( {θ}_{j} , {ϕ}_{j} ) ) + dB ( {w}_{j} {H}_{g}^{i} ( - {θ}_{j} , {ϕ}_{j} ) ) )$$

9. The method according to claim 1, further comprising a step of individualizing the interaural delay (SG), based on a head radius b of a target listener, the interaural delay being determined by
$$\frac{b}{a} τ ,$$
with b the new head radius and a the original radius.

10. The method according to claim 1, further comprising a step, noted SH, of angular correction, with a parameter γ that can be adapted to each user, according to the formulation:
f(θ,φ)=(θ+γ*sin(2θ),φ)

11. The method according to claim 1, further comprising a step, noted SC, of symmetrization and averaging of the phase, according to the formulation:
$$< {H}_{l} ( θ , ϕ ) > = \frac{1}{2 N} {\sum }_{i}^{N} ( < {H}_{g}^{i} ( θ , ϕ ) > + < {H}_{d}^{i} ( ( - {θ}_{j} , {ϕ}_{j} ) > )$$
$$< {H}_{r} ( θ , ϕ ) > = \frac{1}{2 N} {\sum }_{i}^{N} ( < {H}_{d}^{i} ( θ , ϕ ) > + < {H}_{g}^{i} ( ( - {θ}_{j} , {ϕ}_{j} ) > )$$
the notation <.> referring to the phase of the complex transfer function.

12. Headphones configured to implement steps SE to SR of a method according to claim 1.

13. A processing system configured to implement steps S0 to SG of a method according to claim 1.
